(19) United States
(12) Patent Application Publication
(10) Pub. No.: US 2016/0288798 A1
(43) Pub. Date: Oct. 6, 2016

(54) METHOD FOR EVALUATING THE BEHAVIOR OF A DRIVER IN A VEHICLE

(71) Applicant: ROBERT BOSCH GMBH, Stuttgart (DE)

(72) Inventors: Thomas Michalke, Stuttgart (DE); Claudius Glaeser, Ditzingen (DE); Lutz Buerkle, Stuttgart (DE)

(21) Appl. No.: 15/036,733

(22) PCT Filed: Oct. 7, 2014
(86) PCT No.: PCT/EP2014/071450

§ 371 Date: May 13, 2016

(30) Foreign Application Priority Data
Nov. 25, 2013 (DE) 10 2013 224 026.0

(51) Int. Cl. B60W 40/09

(52) U.S. Cl. CPC B60W 40/09

(57) ABSTRACT

In a method for evaluating the behavior of the driver in a vehicle, sensor data are ascertained and the driver behavior is evaluated on the basis of the sensor data. A distinction is made among various behavior categories and the sensor data are allocated to each behavior category with a probability. The behavior category is detected as applicable if the probability exceeds a threshold value.

### FIELD

The present invention relates to a method for evaluating driver behavior in a vehicle.

### BACKGROUND INFORMATION

Driver assistance systems that monitor the driver or vehicle interior, or the vehicle surroundings, with the aid of a sensor suite are available, for example, on the basis of the measured values, actuating signals for impingement upon an actuator suite are ascertained, and the driving behavior of the vehicle can be influenced with them. In braking assistance systems, for example, the brake pedal actuation is monitored, and a brake pressure is built up automatically if the speed or acceleration of the pedal actuation exceeds a limit value.

Braking assistance systems can optionally also be coupled to an electrically assisted steering system having a surroundings monitoring function, in order to connect a deceleration motion of the vehicle to an evasive motion.

The basis of such driver assistance systems is the ascertainment and evaluation of measured values. If the measured values exceed allocated limit values, an intervention via the driver assistance system occurs.

An object of the present invention is to analyze driver behavior in the vehicle so that, for example, driver assistance systems can be adjusted with greater accuracy to the current driving situation.

### SUMMARY

An example method according to the present invention is utilized in order to evaluate driver behavior in a vehicle. Objective and/or subjective driver states can be ascertained and evaluated on the basis of the driver behavior, a distinction being made among various behavior categories. In the method, measured values are ascertained using sensors and are allocated, with various probabilities, to the different driver behavior categories. A behavior category is detected as applicable if the allocated probability exceeds a threshold value.

The example embodiment has the advantage that a distinction can be made among the various behavior categories on the basis of a probabilistic method; for example, a driver assistance system can be parameterized differently depending on the applicable behavior category. For example, various behavior categories for the current concentration state of the driver can be distinguished, for example as a first category the “alert” or “highly concentrating” state, a middle category with a driver of average concentration, and a further category with a less concentrating driver. If the evaluation based on the probabilistic model indicates, in consideration of the sensor data, that the driver is not concentrating, then limit values or threshold values, for example, for a braking assistant or for an electronic stability program (ESP) can be lowered in order to enable an earlier and/or more intense intervention by the relevant driver assistance system. For a driver of average concentration, conversely, the limit values advantageously are modified only slightly, whereas for a highly concentrating driver no change is needed in the pre-settings of the limit values in the driver assistance system.

In the case of a highly concentrating driver it is also possible to modify the limit values so that a later intervention than in the normal state occurs. In the context of warning systems or systems having multiple warning stages in the intervention cascade, a highly concentrating driver may feel, based on his or her subjective perception, that he or she is being warned too often and too early. An adaptation of the limit values would decrease the number of messages perceived by the driver as false warnings, and enhance system acceptance.

Reaction limits or time limits until intervention by the driver system can also be modified, for example, in particular can be lowered in the case of a driver of below-average concentration. An adaptation in the vehicle is therefore achieved for the individual driver and in situation-related fashion, accompanied by improved safety.

With the aid of the probabilistic method, it is thus possible to make a probability statement regarding a specific, currently valid behavior category of the driver, and this can be made the basis for parameterizing an actuator in the vehicle, for example a driver assistance system. All adjustable components in the vehicle can be modified as a function of the current driver behavior category. In addition to driver assistance systems such as a braking assistant or steering assistant or an electronic stability program, this can also relate to parameters of the drive system, for example control times, or to the intervention time or triggering time; for example, in the case of an imminent accident, the time remaining until an automatic braking intervention or steering intervention.

Because probabilities are allocated to the various behavior categories on the basis of data ascertained using sensors, there is greater certainty regarding correct detection of the currently valid behavior category of the driver. The risk of an incorrect decision is reduced.

In the context of the method, complex driver state information can be gathered and environmental data can be included. The mental state of the driver, as well as state transitions, can be modeled as a function of sensor data. The ascertained driver state can be used in order to adapt driver assistance systems in terms of their behavior.

Usefully, continuous sensor data are ascertained during driving operation and are allocated to the various behavior categories. This creates the possibility of sensing changes in the driver's behavior category and making the just-detected behavior category the basis for further adjustments in the vehicle. The driver's concentration can decrease during a longer-duration journey, for example; this is detected on the basis of the sensor data, whereupon the behavior category is switched over toward a less-concentrating behavior pattern. A different parameter set correspondingly takes effect, and is used as the basis for one or more actuators or systems in the vehicle.

Continuous ascertainment and evaluation of the sensor data furthermore has the advantage that a higher probability for a detected behavior category is achieved. If the sensor data do not change, or change only slightly, for a long time, the probability of maintaining a category then continues to increase.

A switchover between the various behavior categories takes place if the probability for the new behavior category that is to be switched into exceeds an allocated probability threshold value. The probability threshold values can be the same or different for the various behavior categories. It is furthermore possible to predefine fixed threshold values or variably adaptable threshold values that can depend in particular on further parameters or state variables of the vehicle or of the driver.

According to an advantageous embodiment a hidden Markov model (HMM) is used as a probabilistic method for evaluating the driver behavior. This is a stochastic model with transition probabilities between various current states. Other probabilistic methods for allocating the sensor data to the various behavior categories of the driver are, however, also possible in principle.

The sensor suite for ascertaining the sensor data that are the basis for allocation to the behavior categories is located in the vehicle and serves, for example, respectively to observe the driver or ascertain a driver actuation. For example, pedal actuation by the driver can be ascertained, for example by way of sensors on the relevant accelerator pedal or brake pedal, by which the pedal speed and/or acceleration is measured. Measurements directly of the driver are also possible, for example sensing gaze direction, foot actuation, or the driver's autonomic nervous system, e.g., pulse rate.

Evaluation of an environmental sensing suite, for example the distance to a third vehicle or to lateral roadway demarcations, is also a possibility.

The probabilistic method can be trained in a preceding training step in which, in order to evaluate the driver behavior, earlier measurement series are assessed in order to obtain a probability allocation to the various behavior categories. A training step of this kind builds in particular on predefined initial values that are improved during the training step and are brought closer to reality. The improved probability values that are allocated to the various behavior categories are then employed in the course of the method. The probability values are, for example, probability functions such as a Gaussian distribution curve; the determining parameters of the distribution curve, such as the average or position, and the standard deviation or height, are determined in the training step.

A training step is also optionally carried out in the course of operation in order to obtain, from the currently acquired measured values, a further improvement in the underlying probability functions or probability distributions for the various behavior categories.

It is generally sufficient to take into account, in the probabilistic method for determining the behavior category, measured values that reflect the driver behavior, the state of the vehicle, or the vehicle situation in terms of third vehicles or externally located objects. It can optionally also be advantageous, however, additionally to take other parameters into account in the probabilistic method, for example the time remaining until occurrence of a predicted accident.

The method executes in a closed- or open-loop control device in the vehicle. The closed- or open-loop control device can optionally be a constituent of a driver assistance system or can interact with a driver assistance system whose parameterization is adjusted as a function of the detected behavior category.

Further advantages and useful embodiments are to be gathered from the description below and the Figures.

### BRIEF DESCRIPTION OF THE DRAWINGS

FIG. 1 schematically depicts a system for evaluating driver behavior, the detected behavior category being delivered to a downstream driver assistance system for parameterization.

FIG. 2 is a 3×3 matrix with switchover probabilities between various driver behavior categories.

FIG. 3 is a matrix having probability functions for various behavior categories depending on values ascertained using sensors.

### DETAILED DESCRIPTION OF EXAMPLE EMBODIMENTS

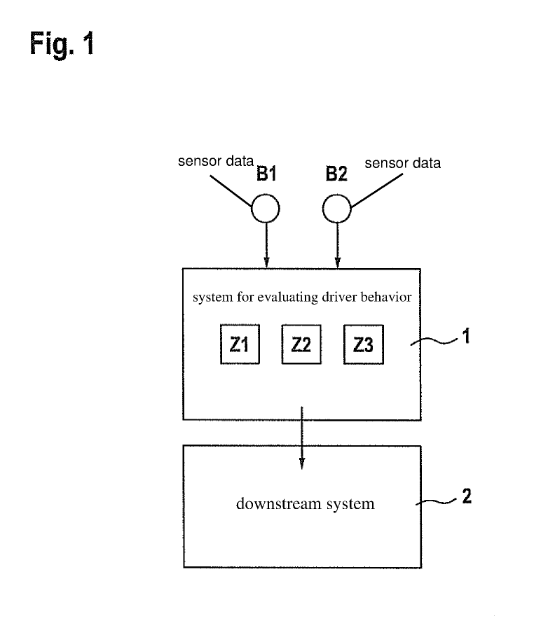

FIG. 1 shows a system 1 for evaluating driver behavior in a vehicle, which encompasses a method executing in a closed- or open-loop control device. In the method in system 1, a distinction is made among different behavior categories of the driver, which are labeled by way of example in FIGS. 1 as Z1, Z2, and Z3. These behavior categories each relate to a specific driver state; for example, Z1 denotes a highly concentrating driver, Z2 a driver of average concentration, and Z3 a non-concentrating driver.

Measured values B1 and B2 are delivered to system 1 from two different sensors, for example measured values B1 to characterize the brake pedal actuation and measured values B2 to characterize the driver's gaze direction. Brake pedal actuation is ascertained, for example, via a sensor on the brake pedal which is capable of measuring the brake pedal acceleration. The driver's gaze direction can be ascertained via a camera system in the vehicle.

The driver's concentration state can be inferred with the aid of the sensor data B1 and B2. For example, a non-concentrating driver tends toward panic reactions, which can be identified via sudden, intense brake pedal actuations. The gaze direction for non-concentrating drivers furthermore corresponds to a specific pattern that can likewise be identified using sensors. Consideration of the measured values from different sensors allows the current concentration state to be identified with high probability and distinguished from other reactions, for example a sudden, justified braking operation by a concentrating driver.

A probabilistic method, which in the exemplifying embodiment is a hidden Markov model (HMM), is taken as the basis for determining the current behavior category Z1, Z2, and Z3 of the driver. In this, a probability is allocated to each behavior state Z1, Z2, and Z3 of the driver from the measurement series of each sensor. If the probability in a driver state Z1, Z2, or Z3 exceeds a given threshold value or limit value, that behavior category is detected as applicable, whereupon a signal is generated which is delivered as an input to the downstream system 2, which can be, for example, a driver assistance system such as a braking assistant and steering assistant. A specific parameter set for the driver assistance system is allocated to each driver state Z1, Z2, Z3. Once the applicable behavior category has been detected, the corresponding parameter set is activated in driver assistance system 2. It is thus possible to parameterize the assistance system as a function of the current driver situation, and adapt it optimally to the current state of the driver.

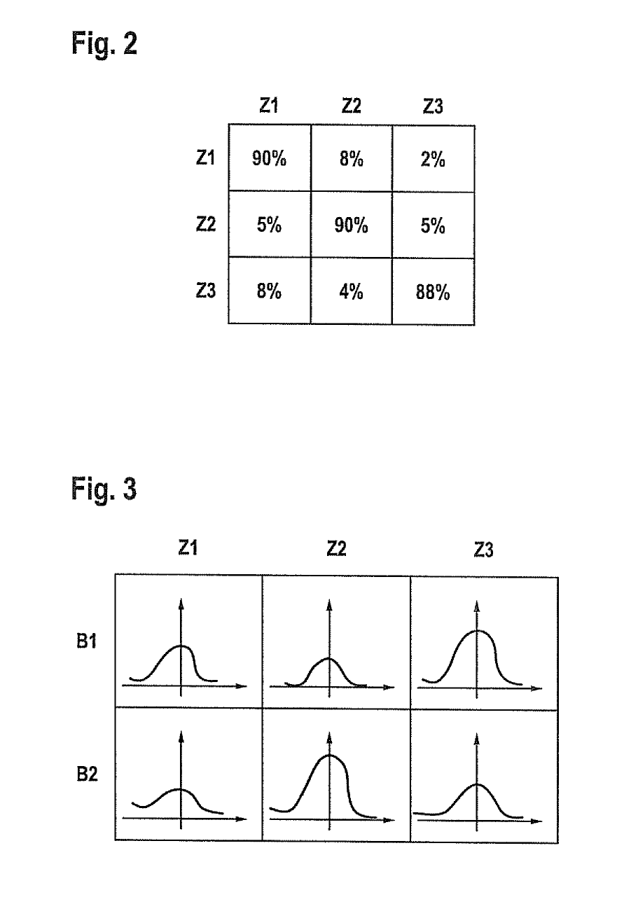

FIG. 2 depicts, in a 3×3 matrix, switchover probabilities between the various driver states Z1, Z2, and Z3. The initial states are located on the left side of the matrix, and the target states along the top side. High probability values are entered along the main diagonal, since a currently valid driver state will also be maintained in the near future with high probability, and a switchover into another behavior category is improbable. The probability values for a switchover between different driver states accordingly are significantly lower.

For example, a probability of 90% is entered in the first field in the first row of the matrix according to FIG. 2, meaning that the driver state Z1 will be maintained in the near future with that probability. A probability of 8% is entered in the second field, which corresponds to a switchover from the driver state Z1 to Z2. The third field has a probability of 2%, this being the probability that a switchover from driver state Z1 to driver state Z3 will occur. The probabilities in each row always add up to 100%.

Corresponding probabilities result for the second row for a switchover from the driver state Z2 to another driver state, and in the third row for the switchover from the driver state Z3 to another driver state.

FIG. 3 depicts the allocation of measured values B1 and B2 to the driver states Z1, Z2, and Z3. The allocation is effected via probability functions that are embodied as Gaussian distribution functions; distribution functions having a different height and standard deviation (probability) and width and average value/position (measured value) are depicted in the various fields. Each measured value B1 and B2 is respectively allocated to a driver category Z1, Z2, and Z3; identical measured values, which correspond to the X axis in the distribution function, result in different probabilities (Y axis). Probabilities totaling 100%, which are distributed among the three fields for Z1, Z2, and Z3, are obtained for each row, i.e., respectively for the measured values B1 and B2. Because of the differently embodied distribution functions, however, the same measured value in each row results in a differing probability value in each field Z1, Z2, Z3.

The probability functions or distribution functions in the various fields are ascertained in a preceding training step in which, for example, earlier measurement series are evaluated and are allocated to the various behavior categories Z1 to Z3.

Measured values B1 and B2 are continuously ascertained in the course of driving operation. Unchanged measured data result in unchanged probabilities in the various fields; as time proceeds, a higher level of certainty is achieved and is expressed as an elevated probability value. If the probability value in one of the fields Z1, Z2, and Z3 exceeds the allocated probability limit value, it can be assumed with sufficient certainty that an applicable behavior category exists, whereupon (as described in FIG. 1) a parameter set corresponding to the relevant behavior category can be activated in the driver assistance system.

1-10. (canceled)

11. A method for evaluating the behavior of a driver in a vehicle, comprising:
ascertaining sensor data; and
evaluating the behavior of the driver based on the sensor data, wherein a distinction is made among various behavior categories and the sensor data are allocated to each behavior category with a probability, a behavior category being detected as applicable if the allocated probability exceeds a threshold value.

12. The method as recited in claim 11, wherein the sensor data are ascertained continuously during vehicle operation and are allocated to the various behavior categories.

13. The method as recited in claim 11, wherein a switchover from a first behavior category to a second behavior category takes place if the probability for the second behavior category exceeds a threshold value.

14. The method as recited in claim 11, wherein a hidden Markov model (HMM) is used as a probabilistic method for evaluating the driver behavior.

15. The method as recited in claim 11, wherein the sensor data is sensor data of a vehicle sensor suite, with which the driver or a driver actuation is observable.

16. The method as recited in claim 14, wherein in a training step, earlier measurement series for ascertaining probability functions allocated to the behavior categories are delivered to the underlying probabilistic method for evaluating the driver behavior.

17. The method as recited in claim 14, wherein during vehicle operation, current measurement series for ascertaining probability functions allocated to the behavior categories are delivered to the underlying probabilistic method for evaluating the driver behavior.

18. The method as recited in claim 11, wherein additional influencing variables dependent on current driving situation are taken into account in determining the probability of a behavior category.

19. The method as recited in claim 11, wherein a time remaining until occurrence of an accident is taken into account in determining the probability of a behavior category,

20. A closed- or open-loop control device for evaluating the behavior of a driver in a vehicle, the device designed to:
ascertain sensor data; and
evaluate the behavior of the driver based on the sensor data, wherein a distinction is made among various behavior categories and the sensor data are allocated to each behavior category with a probability, a behavior category being detected as applicable if the allocated probability exceeds a threshold value.

21. A driver assistance system in a vehicle, comprising:
a closed- or open-loop control device for evaluating the behavior of a driver in a vehicle, the device designed to ascertain sensor data, and evaluate the behavior of the driver based on the sensor data, wherein a distinction is made among various behavior categories and the sensor data are allocated to each behavior category with a probability, a behavior category being detected as applicable if the allocated probability exceeds a threshold value, parameterization of the driver assistance system being adjusted as a function of the detected behavior category.
